(19) United States
(12) Patent Application Publication
(10) Pub. No.: US 2026/0276557 A1
(43) Pub. Date: Sep. 17, 2026

(54) METHODS FOR CALIBRATING A NON-DESTRUCTIVE TESTING APPARATUS

(71) Applicant: Airbus SAS, BLAGNAC (FR)

(72) Inventors: Tejas Shriprakash TADPATRIKAR, FILTON (GB); Sagnik CHAKRABORTY, FILTON (GB); Anurag BANSAL, FILTON (GB)

(21) Appl. No.: 19/558,982

(22) Filed: Mar. 6, 2026

(30) Foreign Application Priority Data
Mar. 13, 2025 (IN) 202511022600

(51) Int. Cl. G01N 21/93; G01D 18/00; G01H 3/00; G01N 21/88; G01T 7/00; G06T 7/00

(52) U.S. Cl. CPC G01N 21/93; G01D 18/008; G01H 3/005; G01N 21/8851; G01T 7/005; G06T 7/001; G01N 2021/8893; G06T 2207/10121

(57) ABSTRACT

An apparatus for guiding an equipment calibration process, the apparatus comprising one or more processors configured to: receive an image of a calibration object; obtain a reference image of the calibration object, the reference image comprising a representation of the calibration object and a graphical element indicative of one or more calibration features of the calibration object; simultaneously output the received image and the reference image on a display unit; and output, on the display unit, an indication of whether one or more of the calibration features of the calibration object have been identified in the received image.

### CROSS-REFERENCES TO RELATED APPLICATIONS

This application claims the benefit of Indian Patent Application Number 202511022600 filed on Mar. 13, 2025, the entire disclosure of which is incorporated herein by way of reference.

### FIELD OF THE INVENTION

The present invention relates to a method and apparatus for calibrating a non-destructive testing apparatus.

### BACKGROUND OF THE INVENTION

Non-Destructive Testing (often referred to as “NDT”) is widely used throughout the aerospace industry for inspecting aircraft components.

Non-Destructive Testing is typically performed with the assistance of an associated NDT apparatus such as an ultrasonic (UT) or X-Ray scanner. However, before inspection of an aircraft component can commence, the associated NDT apparatus must first be calibrated against a suitable control sample to ensure that defects above a minimum detectable defect size can be detected.

Currently, when calibrating an NDT apparatus, an operator (or inspector) is required to use the NDT apparatus to inspect the control sample and then compare the results obtained during said inspection to an associated reference standard to ensure that all of the known defects present within the control sample have been duly detected.

However, it shall be appreciated that performing such calibration processes prior to each inspection is very time-consuming.

Furthermore, when calibrating an NDT apparatus, the operator will typically be required follow a pre-approved calibration procedure corresponding to the aircraft component undergoing inspection and/or the type of NDT apparatus being used to perform the inspection. The pre-approved calibration procedure will typically set out the particular areas of the control sample which must be inspected and also the particular techniques and methods which should be utilized when inspecting the control sample to ensure that the NDT apparatus is properly calibrated.

However, given the large number of components present on a given aircraft, it is unrealistic for an operator to be expected to properly memorize all of the respective calibration procedures required for each control sample.

Therefore, to help address this issue, the aforementioned calibration procedures are often provided on physical “technique cards” which must be obtained by the operator and studied thoroughly prior to each calibration. However, it shall be appreciated that obtaining and studying such “technique cards” prior to each calibration is also very time-consuming.

It is therefore an aim of the present invention to address one or more of the aforementioned disadvantages associated with known calibration procedures.

### SUMMARY OF THE INVENTION

A first aspect of the invention provides an apparatus for guiding an equipment calibration process, the apparatus comprising one or more processors configured to: receive an image of a calibration object; obtain a reference image of the calibration object, the reference image comprising a representation of the calibration object and a graphical element indicative of one or more calibration features of the calibration object; simultaneously output the received image and the reference image on a display unit; and output, on the display unit, an indication of whether one or more of the calibration features of the calibration object have been identified in the received image.

Advantageously, by virtue of this arrangement the user is provided with continuous assistance when performing the calibration process. That is, the apparatus outputs information which guides the user in their interaction with the apparatus and/or the calibration apparatus.

In some examples, the calibration object is an aircraft component. Aircraft components may have complex shapes and reference aircraft components with artificial defects may be provided to ensure that a testing apparatus is properly calibrated. There are many varied aircraft components, and this necessitates the use of reference images including information about calibration features (such as artificial defects). The invention therefore provides the user with further assistance during the performing of the calibration process by outputting an appropriate reference image simultaneously with the image of the calibration object.

In some examples, the artificial defect may comprise, or may be configured to simulate, an area of delamination, a foreign object or piece of debris, an area of porosity and/or a crack.

In some examples, the one or more processors are further configured to identify one or more of the calibration features in the received image. Thus, the apparatus may indicate to a user which of the known calibration features have been successfully identified, thereby assisting the user in completing the calibration process.

In some examples, the one or more processors are further configured to receive a measurement associated with an identified calibration feature. Thus, as well as guiding a user during the calibration process, the apparatus may also provide convenient record keeping of measurements taken during the process.

In some examples, the one or more processors are further configured to receive a user input identifying a calibration feature in the received image.

In some examples, the apparatus is communicatively coupled to a scanning apparatus, and the one or more processors are further configured to identify one or more calibration features based on an input signal received from the scanning device. Thus, the apparatus may update the display based on measurements reflecting the real environment, further informing the user as to the performance of the calibration process.

In some examples, the one or more processors are further configured to compare, using image processing techniques, the received image to the reference image to determine whether the calibration features of the calibration object indicated in the reference image have been identified in the received image. The apparatus may therefore update its output to reflect progress in the calibration process and may effectively guide the user by providing an indication of which calibration features have or have not been identified.

In some examples, the one or more processors are further configured to receive a user input indicative of an identified calibration feature in the received image corresponding to a calibration feature of the reference image.

In some examples, the one or more processors are further configured to visually highlight calibration features of the reference image which are not identified in the received image. The user may thereby quickly identify calibration features which have not been identified and may direct the calibration process in response.

In some examples, the one or more processors are further configured to overlay the reference image over the received image. Advantageously, the user may continuously perform the calibration process without needing to turn away from the calibration object to review the reference image.

In some examples, the one or more processors are further configured to align the reference image over the received image using image processing. User input to effectively perform the calibration process using the apparatus is thereby reduced.

In some examples, the one or more processors are further configured to output a user interface element indicating one or more of: a total number of calibration features of the calibration object; a number of identified calibration features; a number of unidentified calibration features; or instructions to scan the calibration object at an area associated with an unidentified calibration feature. The user is thereby informed of the status of the calibration process and may perform the calibration process correctly in response to this information.

In some examples, the apparatus comprises a virtual reality, VR, or augmented reality, AR, wearable device. Advantageously, the user may continuously perform the calibration process without needed to turn away from the calibration object to review the reference image.

In some examples, the one or more processors are further configured to obtain the reference image from a memory of the apparatus or an external server storing a plurality of reference images associated with a respective plurality of calibration objects.

In some examples, the one or more processors are further configured to obtain the reference image based on one or more of: a user input selecting the reference image from the plurality of stored reference images; an identifier of the calibration object detected in the received image; or performing object recognition on the received image and identifying a type of the object in the received image. Advantageously, the reference image may be obtained from a potentially large library of reference images in an efficient manner with reduced user inputs.

In some examples, the identifier of the calibration object comprises a QR code or a bar code.

In some examples, the reference image comprises one or more 2D images of the calibration object or a 3D image of the calibration object. The apparatus is therefore suitable for guiding the calibration process with a variety of different shaped calibration objects.

In some examples, the apparatus is communicatively coupled to an imaging device configured to capture the image of the calibration object, or the apparatus is communicatively coupled to a scanning device configured to perform non-destructive testing on the object, and the received image of the calibration object is received from the imaging device or the scanning device.

In some examples, the apparatus comprises the imaging device; wherein the imaging device comprises a camera device.

In some examples, the scanning device comprises an ultrasound or x-ray scanning device.

In some examples, the one or more calibration features comprise an artificial defect. Thus, the calibration process ensures that a testing apparatus is properly calibrated to detect defects in the calibration objects.

In some examples, the one or more processors are further configured to generate a report to certify that all of the calibration features of the reference image have been identified in the received image, and that the equipment calibration process has been completed. Thereby, reliable records may be kept to ensure that the calibration process is correctly performed.

In some examples, the reference image further comprises calibration feature data associated with the calibration features, and wherein said calibration feature data comprises a signal amplitude of an artificial defect and/or a gain value of the artificial defect, and wherein the wherein the one or more processors are further configured to display calibration feature data on the display unit. Thus, when the user is also using a sensing device or testing apparatus, the user may be presented with relevant information which guides their interaction with the sensing device to correctly detect the calibration features.

A further aspect of the invention provides a system comprising the apparatus of any preceding statement and an imaging device configured to capture the image of the calibration object, or a scanning device configured to perform non-destructive testing on the calibration object.

A further aspect of the invention provides a method for guiding an equipment calibration process, the method comprising: receiving an image of a calibration object; obtaining a reference image of the calibration object, the reference image comprising a representation of the calibration object and a graphical element indicative of one or more calibration features of the calibration object; simultaneously outputting the received image and the reference image on a display unit; and outputting, on the display unit, an indication of whether one or more of the calibration features of the calibration object have been identified in the received image.

A further aspect of the invention provides a method for calibrating a non-destructive testing apparatus, wherein the method comprises the steps of:
selecting a control sample corresponding to a component to be inspected, and retrieve a reference standard corresponding to the selected control sample among a plurality of reference standards in a computer-readable storage medium, wherein each reference standard is associated with a respective one of the plurality of control samples, wherein each control sample features an artificial defect, wherein the reference standard comprises a master image of the selected control sample indicating the location of the artificial defect;
capturing an image of the selected control sample using a non-destructive testing apparatus;
displaying the captured image of the control sample on a display unit, wherein the master image is overlaid onto the captured image; and
determining, based on the captured image and the master image, whether or not the artificial defect has been detected by the non-destructive testing apparatus.

### BRIEF DESCRIPTION OF THE DRAWINGS

Embodiments of the invention will now be described with reference to the accompanying drawings, in which:

FIG. 1 shows a schematic plan view of an aircraft;

FIG. 2 shows a perspective view of an aircraft component;

FIG. 3A shows a schematic side view of a non-destructive testing apparatus for inspecting the aircraft component illustrated in FIG. 2;

FIG. 3B shows another schematic side view of a non-destructive testing apparatus for inspecting the aircraft component illustrated in FIG. 2;

FIG. 4 shows a block diagram illustrating an apparatus for performing a calibration process for a non-destructive testing apparatus;

FIG. 5 shows a block diagram illustrating a system for performing a calibration process for a non-destructive testing apparatus;

FIG. 6 shows a flow chart illustrating a method for performing a calibration process for a non-destructive testing apparatus;

FIG. 7 illustrates a user interface displayed during a calibration process using an automated non-destructive testing apparatus;

FIG. 8 illustrates user interfaces displayed during a calibration process using an automated non-destructive testing imaging apparatus;

FIG. 9 shows a flow chart illustrating a method for performing a calibration process using an automated non-destructive testing apparatus;

FIG. 10 illustrates a user interface displayed during a calibration process using an imaging device;

FIG. 11 illustrates user interfaces displayed during a calibration process using an imaging device; and

FIG. 12 shows a flow chart illustrating a method for performing a calibration process for a non-destructive testing apparatus using an imaging device.

### DETAILED DESCRIPTION OF THE PREFERRED EMBODIMENTS

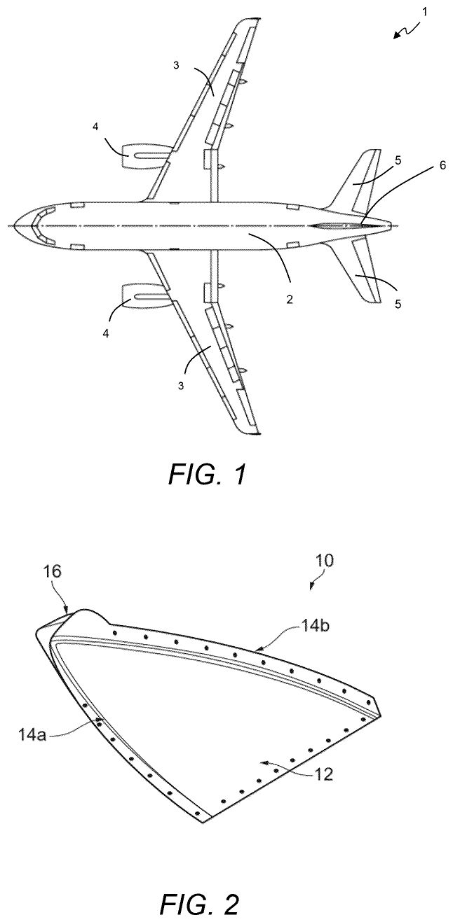

FIG. 1 shows an aircraft 1. The aircraft 1 has a fuselage 2, and starboard and port fixed wings 3. An engine 4 is mounted to each wing 3. The aircraft 1 also comprises an empennage (or tail assembly) which includes starboard and port horizontal stabilizers 5 and a vertical stabilizer 6.

In the embodiment illustrated in FIG. 1, the aircraft 1 is a typical jet passenger transport aircraft but the invention is applicable to a wide variety of fixed wing aircraft types, including commercial, military, passenger, cargo, jet, propeller, general aviation, etc. with any number of engines 4 attached to the wings 3 or fuselage 2.

The fuselage 2, wings 3, engines 4 and empennage of the aircraft 1 are each made up of a plurality of aircraft components 10 which must be routinely inspected at various points throughout the service life of the aircraft 1.

An example of one such aircraft component 10 is shown in FIG. 2.

In the illustrated embodiment, the aircraft component 10 is a fairing component which forms part of the aircraft “flap track” fairing. However, it shall be appreciated that in other embodiments, the aircraft component 10 may be of a different type.

As shown in FIG. 2, the aircraft component 10 comprises a planar web which forms a bottom surface 12 of the aircraft component 10 and a pair of flanges 14a, 14b which extend along opposing peripheral edges of the planar web 12.

In the illustrated embodiment, the opposing peripheral edges of the planar web 12 converge at one end of the aircraft component 10 to define a nose portion 16.

However, it shall be appreciated that in other embodiments, the aircraft component 10 may have a different shape.

In some embodiments, the aircraft component 10 may be formed of a metallic material. For example, the aircraft component 10 may be formed of aluminum, magnesium, titanium and/or steel.

In other embodiments, the aircraft component 10 may be formed of a composite material. For example, the aircraft component 10 may be formed of a carbon-fiber reinforced polymer (or CFRP) or may be formed of a glass-fiber reinforced polymer (GFRP).

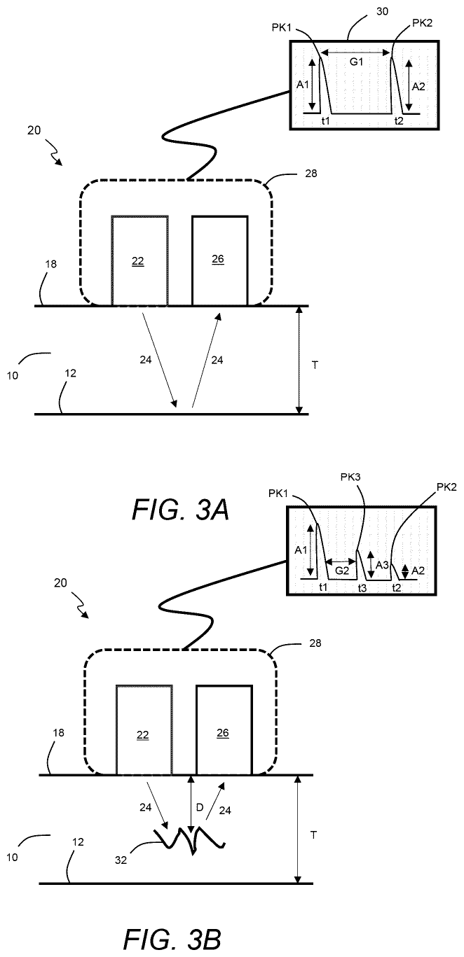

Referring now to FIG. 3, it shall be appreciated that the aircraft component 10 will typically require inspection during a “quality control process” prior to said component 10 being installed onto the aircraft 1 and also at various points throughout the service life of the aircraft component 10. For example, the aircraft component 10 may require inspection after a pre-determined number of flight hours have elapsed and/or after a pre-determined distance has been travelled by the aircraft 1 onto which the aircraft component 10 has been installed.

The inspection of such aircraft components 10 is often performed using Non-Destructive Testing (or NDT) techniques including, but not limited to, ultrasonic (UT) inspection, X-ray inspection, radiographic inspection; eddy current inspection, magnetic particle inspection, visual inspection and/or liquid penetrant inspection.

The term “Non-Destructive Testing” is defined herein as a method of determining one or more properties of a material and/or component without causing damage to (or otherwise adversely affecting the integrity of) the material and/or component being subjected to the testing procedure.

FIGS. 3A and 3B show a schematic illustration of a non-destructive testing apparatus 20 suitable for inspecting the aircraft component 10 illustrated in FIG. 2.

In the illustrated embodiment, the non-destructive testing apparatus 20 is an ultrasonic testing apparatus. However, it shall be appreciated that in other embodiments, the non-destructive testing apparatus 20 may be of a different type. For example, in some embodiments, the non-destructive testing apparatus 20 may be an X-ray testing apparatus.

As shown in FIGS. 3A and 3B, the non-destructive testing apparatus 20 comprises a source 22 which is configured to emit an pulse 24 of ultrasonic energy towards the aircraft component 10 and a corresponding transducer 26 which is configured to detect the pulse 24 of ultrasonic energy as it reflects (or echoes) back off one or more features of the aircraft component 10.

It shall be appreciated that the source 22 and the associated transducer 26 may be provided as separate components or as shown in FIG. 3, may be incorporated into a single probe 28.

Referring firstly to FIG. 3A, ultrasonic inspection is performed via placing the source 22 onto a surface (in this case a top surface 18) of the aircraft component 10 and emitting an pulse 24 of ultrasonic energy towards the aircraft component 10 such that the pulse 24 of ultrasonic energy can propagate through the material of the component 10.

In the case of FIG. 3A in which no substantial defects are present within the aircraft component 10, the pulse 24 of ultrasonic energy will propagate through the full thickness (T) of the component 10 before reaching a bottom surface 12 at which point the pulse 24 of ultrasonic energy will be reflected back towards the transducer 26.

When the reflected pulse 24 reaches the transducer 26, the transducer 26 transforms the reflected pulse 24 into an electrical signal which is then subsequently displayed on a display unit 30 so that it can be viewed and interpreted by an operator.

In particular, the display unit 30 displays the amplitude (or strength) A of the detected pulses and also the time (t) at which the pulses 24 were detected.

As shown in FIG. 3A, when no substantial defects are present within the aircraft component 10, the signal displayed on the display unit 30 shows a first peak (PK1) at a first time (t1) which corresponds to the transducer 26 detecting the initial pulse 24 being emitted from the source 22 and a second peak (PK2) at a second time (t2) which corresponds to the transducer 26 detecting the reflected pulse 24 (or echo) as it reaches the transducer 26 having reflected back off the bottom surface 12 of the component 10.

It shall be appreciated that since substantially all of the pulse 24 is reflected off the bottom surface 12 of the aircraft component 10, the amplitude (A2) of the second peak (PK2) should be approximately equal to that of the first peak (PK1) if no defects are present within the aircraft component 10.

It shall also be appreciated that the time gap (G1) between the first (PK1) and second (PK2) peaks should also correspond to the thickness (T) of the aircraft component 10.

Referring now to FIG. 3B, in some instances, the aircraft component 10 may comprise a defect 32. In the case that a defect 32 is present within the thickness of the aircraft component 10, rather than propagating through the full thickness of the aircraft component 10, at least a portion of the pulse 24 will reflect back off the defect 32 towards the transducer 26.

It shall be appreciated that the defect 32 may be an area in which one or more of the composite plies which make up the aircraft component 10 have become delaminated; a foreign object which has been inadvertently captured within the thickness of the aircraft component 10; an area of porosity within the thickness of the aircraft component 10; a crack present within the thickness of the aircraft component 10, and/or another type of defect.

As such, in the event that a defect 32 is present within the thickness of the aircraft component 10, the signal displayed on the display unit 30 will show a first peak (PK1) at a first time (t1) which corresponds to the transducer 26 detecting the initial pulse 24 being emitted from the source 22, a second peak (PK2) at a second time (t2) which corresponds to the transducer 26 detecting the reflected pulse 24 (or echo) as it reaches the transducer 26 having reflected back off the bottom surface 12 of the component 10, and also a third peak (PK3) which corresponds to the transducer 26 detecting the reflected pulse 24 as it reaches the transducer 26 having reflected back off the defect 32.

As shown in FIG. 3B, the time (t3) at which the third peak (PK3) is detected by the transducer 26 is typically much sooner than the time (t2) at which the second peak (PK2) is detected since the pulse 24 reflecting off of the defect 32 has a much shorter distance to travel. In other words, the time gap (G2) between the first (PK1) and third peaks (PK3) is shorter than the time gap (G1) between the first (PK1) and second (PK2) peaks.

Furthermore, the respective amplitudes of the second (PK2) and third (PK3) peaks will also typically be less than the amplitude (A1) of the first peak (PK1) when a defect is present within the aircraft component 10.

As such, by analyzing the quantity and associated amplitudes (A) of the respective peaks (PK2 and PK3), and also the times (t) at which the pulses 24 were detected by the transducer 26, an operator is able to accurately determine whether or not a defect 32 is likely to be present within the aircraft component 10.

Furthermore, in the event that a defect 32 is detected, the operator can also approximate the depth (D) of the defect 32 within the thickness of the aircraft component 10 based on the ratio between the first (G1) and second (G2) time gaps.

However, before the non-destructive testing apparatus 20 can be used to inspect an in-service aircraft component 10, it must first be calibrated against a suitable control sample to ensure that the apparatus 20 is able to detect defects above a minimum detectable defect size.

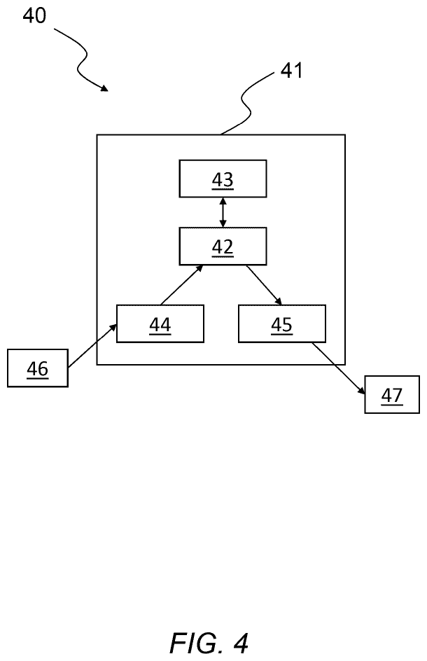

FIG. 4 shows an apparatus 40 for guiding an equipment calibration process, such as a process for calibrating the non-destructive testing apparatus 20 described with reference to FIG. 3.

The apparatus 40 as illustrated in FIG. 4 comprises one controller 41, although it will be appreciated that this is merely illustrative. The controller 41 comprises processing means 42 and memory means 43. The processing means 42 may be one or more electronic processing devices 42 which operably execute computer-readable instructions. The memory means 43 may be one or more memory devices. The memory means 43 is electrically coupled to the processing means 42. The memory means 43 is configured to store instructions, and the processing means 42 is configured to access the memory means 130 and execute the instructions stored thereon.

The controller 41 comprises an input means 44 and an output means 45. The input means 44 is configured to receive an image 46 of a calibration object. The output means 44 is configured to output one or more control signals 47.

The input means 44 may be communicatively coupled to a further part of the apparatus 40 or to an external device. The input means 44 may be communicatively coupled to an imaging device, such as a camera, or a scanning device, such as a non-destructive testing apparatus like those discussed above. The input means 44 may be configured to receive an image 46 of a calibration object. The image 46 may be a photographical image (e.g., such as captured by an imaging device) or a scan image (such as captured by a scanning device).

The controller 41 is configured to obtain a reference image of the calibration object. The reference image comprises a representation of the calibration object and an indication of one or more calibration features of the calibration object. The calibration object may be an aircraft component such as the component 10 described in FIG. 2, and the calibration feature may comprise one or more artificial defects as discussed in respect of FIG. 3.

The controller 41 may be configured to obtain the reference image from a plurality of reference images stored in a memory. The plurality of reference images may be stored in the memory means 43 of the apparatus 40 and may be retrieved by the controller 41 or may be stored in a memory of an external device or server and retrieved via the input means 44.

The controller 41 may determine a reference image which corresponds to the calibration object captured in the received image 46. The appropriate reference image may be determined based on a user input (e.g., a selection of a reference image corresponding to the same type of component as the calibration object) or may be determined automatically based on the received image 46. For example, the calibration object captured in the received image 46 may comprise one or more computer-readable identifiers (such as a QR code, a bar code or a serial number), which may be read by the controller 41 (for example using suitable image processing techniques) and which may identify the appropriate reference image.

The reference image may include one or more 2D images of the calibration object or may include a 3D image such as a CAD model of the calibration object. The reference image may include information relating to the calibration features of the calibration object. For example, the reference image may include information indicative of a number of calibration features, the location of the calibration features, and/or information relating to a measurement associated with the calibration features. The measurement associated with the calibration features may include a signal amplitude and/or a gain value detectable by testing or scanning devices, such as discussed above in respect of FIG. 3.

The controller 41 is further configured to output, via the output means 45, a control signal 47 to cause a display unit to display the received image 46 and the reference image.

The display unit may be part of the apparatus 40 or may be an external display unit. The display unit may comprise any suitable display, for example a smart phone display or a personal computer display. In one example, the apparatus 40 may be an augmented reality, AR, or virtual reality, VR, wearable device. In this case, the display unit may be a screen which faces a user's eyes.

The received image and the reference image may be output simultaneously on the display unit. In one example, the received image and the reference image may be overlaid such that a user can see both images simultaneously, and the images may be aligned so that differences between the received image and the reference image are easily identifiable. The received image and the reference image may be aligned via a user input, or via image processing techniques such as the use of reference points in the images, image recognition, and the like.

The controller 41 is further configured to output, on the display unit, an indication of whether one or more of the calibration features of the calibration object have been identified in the received image. The controller 41 may be configured to output a graphical user interface element, GUI, indicative of identified calibration features in the received image. The controller 41 may alternatively or in addition be configured to output a GUI indicative of a number of calibration features known from the reference image, a number of calibration features identified in the received image, and/or a number of calibration features yet to be identified in the received image. In this way, the user may be assisted in performing the calibration process, as they may be presented with information indicative of which of the known calibration objects have been identified in the received image, and/or which of the known calibration objects have not been identified. The user may thereby be assisted in performing the calibration process by being better informed as to actions needed to finish the process.

The controller 41 may further be configured to identify one or more of the calibration features in the received image. The controller 41 may also be configured to receive, via the input means 44, a measurement (such as a signal amplitude or gain value) associated with an identified calibration feature.

The controller 41 may be configured to identify the calibration features in the received image using one or more of a user input identifying a calibration feature in the received image, an input signal received from a scanning device, or image processing techniques. For example, a user input may be received which is indicative of the user having identified a calibration feature (for example, based on readings from an external sensing device). The user input may include a location of the calibration feature in the received image, and/or a measurement associated with the calibration feature. The user input may alternatively or in addition be received on a known calibration feature displayed as part of the reference image. Here, the user input may confirm that the known calibration feature has been identified.

Alternatively, or in addition, the apparatus 40 may be communicatively coupled to a scanning apparatus, and the controller 41 may be configured to identify one or more calibration features based on an input signal received from the scanning device. The scanning apparatus may be an NDT apparatus as discussed in respect of FIG. 3 and may transmit measurements to the apparatus 40 or may transmit indications of identified calibration features based on measurements of the calibration object.

The controller 41 may further be configured to compare the received image 46 and the reference image to determine which calibration features have been identified in the received image 46. For example, the controller 41 may use image processing techniques to determine whether a calibration feature has been identified in the received image which corresponds to a known calibration feature of the reference image. To this end, the controller 41 may use image processing techniques, and optionally reference objects included on a surface of the calibration object, to align the received image 46 and the reference image.

The apparatus 40 may further be configured to cause the display of a user interface including GUIs indicative of one or more of a total number of calibration features of the calibration object; a number of identified calibration features; a number of unidentified calibration features; or instructions to scan the calibration object at an area associated with an unidentified calibration feature. Thus, the apparatus 40 may assist the user in correctly performing the calibration process.

In some examples, the calibration object may be an aircraft component, and the calibration feature may comprise an artificial defect. Further, the scanning device may comprise an ultrasound or x-ray device. However, the disclosure is not limited thereto, and it should be understood that the apparatus 40 may be suitable for guiding the user in performing other technical processes, such as during the manufacture of aircraft components, or during manufacture, calibration or testing of different physical parts.

The apparatus 40 may further be configured to output a control signal indicative of the calibration process being complete in response to all known calibration features of the reference image being identified in the received image 46.

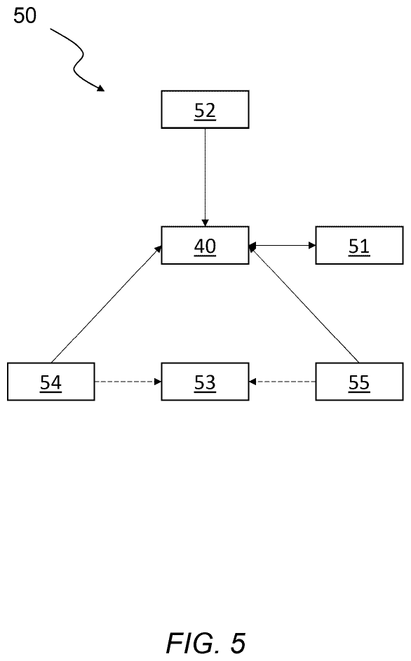

FIG. 5 shows a block diagram illustrating a system 50 according to an embodiment of the invention. The system 50 may be a system 50 suitable for performing a calibration process, such as a calibration process using non-destructive testing equipment on aircraft components, as has been discussed before, although it should be understood that the system 50 is not limited thereto.

The system 50 shown in FIG. 5 comprises the apparatus 40 of FIG. 4, a server 51, a user input means 52, a calibration object 53, an imaging device 54 and a scanning device 55. However, as will be explained, the system 50 may not comprise all devices shown in FIG. 5, and one or more of these devices may be omitted. Further, the functions of the system 50 as will be described below may be performed by a distributed system as described or may be performed by fewer integrated devices.

The apparatus 40 may be the apparatus 40 described above in respect of FIG. 4. The apparatus 40 may be communicatively coupled to the user input means 52 and may be configured to receive user inputs as already described in FIG. 4.

The apparatus 40 may further be communicatively coupled to a server 51. The server 51 may be a local or cloud server and may be configured to store the plurality of reference images. The server 51 may further be configured to receive a report from the apparatus 40 indicative of completion of the calibration process.

The system 50 may optionally comprise an imaging device 54 and/or a scanning device 55. The imaging device 54 may be a camera device and may be configured to capture an image of the calibration object 53 and transmit the captured image to the apparatus 40. The scanning device 55 may be a non-destructive testing apparatus such as the apparatus described in respect of FIG. 3 and may be configured to scan the calibration object 53 and transmit one or more scans of the calibration object 53 to the apparatus.

The user input means 52 may be a touch screen, a keyboard and mouse, a microphone for receipt of voice commands, or any other user input means. The user input means 52 may be integrally formed as part of the apparatus 40.

The apparatus 40 may optionally perform the functions of the user input means 52, the server 51, the imaging device 54 and/or the scanning device 55. That is, in some examples, the system 50 may be implemented as a single device, or as fewer devices than shown in FIG. 5.

The apparatus 40 may further comprise a display unit, or the system 50 may further comprise a separate display unit not shown in FIG. 5. Alternatively, or in addition, the imaging device 54, the scanning device 55, the user input means 51 and/or the server 51 may be configured so as to include the display unit for displaying the received image 46 of the calibration object 53 and the associated reference image.

In one example, the apparatus 40 is an AR or a VR wearable device such as a headset and is configured with integrated user input means 52 and/or an integrated imaging device 54.

Further, it should be understood that although certain communication couplings are exemplified in FIG. 5, the various devices of the system 50 of FIG. 5 may communicate with each other differently.

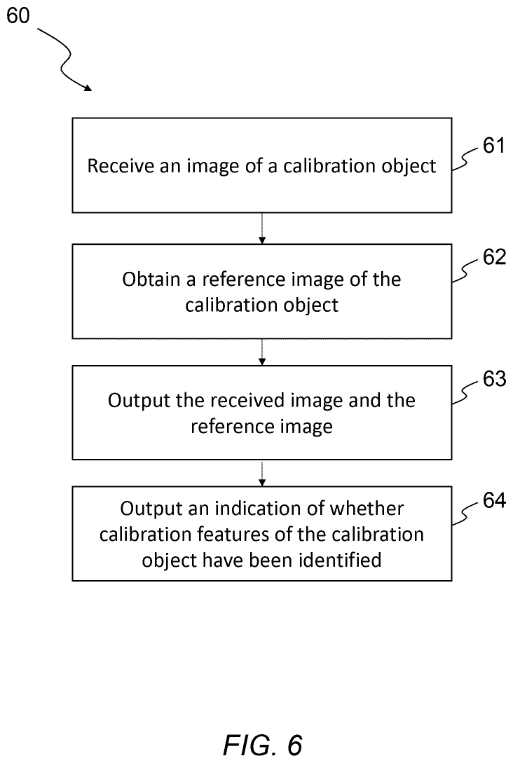

FIG. 6 shows a flow chart illustrated as a method 60 according to an embodiment of the invention. The method 60 may be a method for guiding an equipment calibration process and may be performed by the apparatus 40 of FIG. 4 or the system 50 of FIG. 5.

The method 60 includes receiving 61 an image of a calibration object 53. As has been discussed, in some examples, the received image is an image captured by an imaging device, and in other examples is an image captured by a scanning device.

The method 60 further comprises obtaining 62 a reference image of the calibration object 53. The reference image comprises a representation of the calibration object 53 and a graphical element indicative of one or more calibration features of the calibration object 53. The reference image may be obtained in a variety of ways as discussed above.

The method 60 further comprises outputting 63 the received image and the reference image on a display unit. The received image and the reference image may be overlaid on the display unit.

The method 60 further comprises outputting 64, on the display unit, an indication of whether one or more of the calibration features of the calibration object 53 have been identified in the received image. It should be understood that the indication may take various forms. For example, the indication may include an indication of which calibration features have been identified, an indication of known calibration features which have not been identified, and/or a total number of calibration features of the calibration object 53.

It should be understood that the method 60 may comprise additional steps to those shown in FIG. 6. That is, the method 60 may include performing any further functions of the apparatus 40 described in respect of FIG. 4 above. In particular, the method 60 may further comprise identifying one or more of the calibration features in the received image, receiving a measurement associated with an identified calibration feature, and/or comparing, using image processing techniques, the received image to the reference image to determine whether the calibration features of the calibration object indicated in the reference image have been identified in the received image as described above.

The method 60 may further comprise outputting a further user interface element indicative of one or more of: a total number of calibration features of the calibration object; a number of identified calibration features; a number of unidentified calibration features; or instructions to scan the calibration object at an area associated with an unidentified calibration feature.

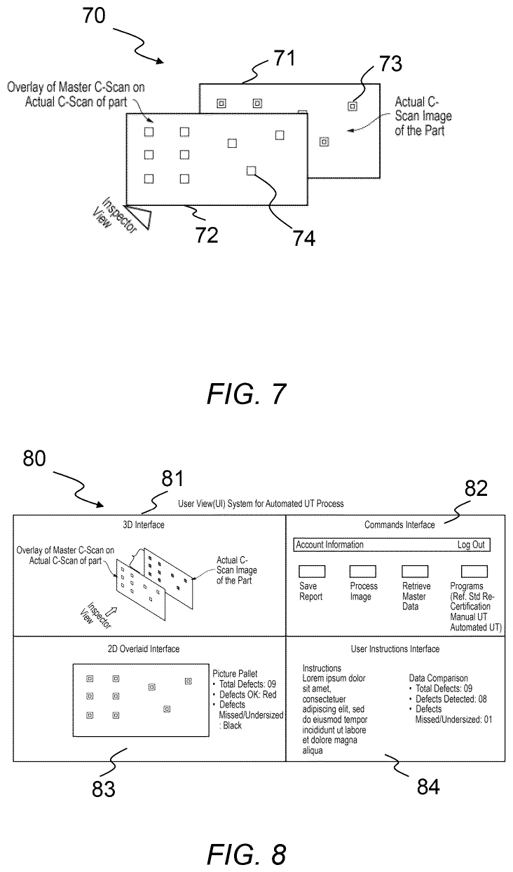

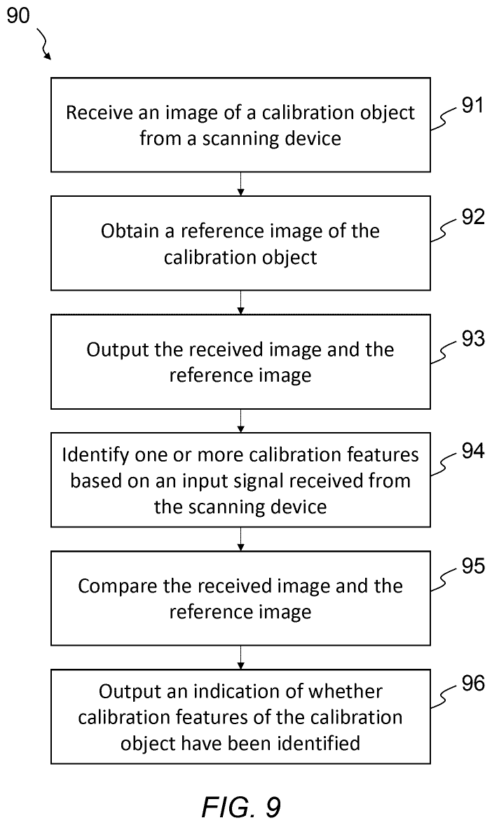

FIGS. 7 and 8 illustrate example user interface elements which may be output during an automated calibration process. The automated calibration process is described in respect of FIG. 9 and may be understood as a calibration process such as that described in respect of FIG. 6, where the method additionally involves receiving a scan of the calibration object 53 from a scanning device 55.

Referring first to FIG. 7, FIG. 7 illustrates a user interface 70 exemplifying how the received image 71 and the reference image 72 may be overlaid or simultaneously displayed. As shown in FIG. 7, the received image 71 may be a scan image of a calibration object 53 received from a scanning device 55. The reference image 72 may be a reference scan image obtained from a memory of the apparatus 40 or the server 51. The received image 71 may include one or more detections of calibration features 73 which may be determined by the scanning device 55 and/or the system 50 based on measurements of the calibration object 53, for example based on a signal amplitude and/or gain value as discussed in respect of FIG. 3. The reference image 72 may include one or more known calibration features 74.

The reference image 72 and the received image 71 may be overlaid over one another. That is, the reference image 72 and the received image 71 may be aligned so as to show substantially the same view of the calibration object 53. The reference image 72 and the received image 71 may be aligned via user inputs to move one or more of the reference image 72 and the received image 71, or the reference image 72 and the received image 71 may be aligned by the apparatus 40 using image processing techniques.

By overlaying the reference image 72 and the received image 71, the user is assisted in performing the calibration process, because the user may easily compare whether all of the known calibration features 74 of the reference image 72 correspond to identified calibration features 73 in the received image 71. The user interface 70 may further output additional user interface elements to further assist the user, for example by highlighting identified and/or unidentified calibration features.

As discussed above, the apparatus 40 may further be configured to perform image processing to determine which of the known calibration features 74 of the reference image 72 have been identified in the received image 71.

Turning to FIG. 8, FIG. 8 illustrates various user interface screens 80 which may be displayed to a user. For example, the user interface screens of FIG. 8 may be displayed during execution of the method 60, 90 of FIG. 6 or 9 by the apparatus 40 of FIG. 4 or the system 50 of FIG. 5.

The user interface screens 80 of FIG. 8 include a first user interface screen 81, a second user interface screen 82, a third user interface screen 83 and a fourth user interface screen 84. It should be understood that the user interface screens may take numerous suitable forms and should not be limited to the examples shown in FIG. 8.

The first user interface screen 81 is a 3D overlay of the reference image 72 and the received image 71 and has been described in respect of FIG. 7.

The second user interface screen 82 may be a command interface and may include various options for the user to initiate, execute or terminate stages of the equipment calibration process 60, 90. For example, the user interface screen 82 may include button elements for a user to select a reference image.

The third user interface screen 83 may be a 2D overlay view. The user may select between the 3D and 2D overlay views depending on their preference, depending on a type of device used to execute the process, or depending on a type of the calibration object 53. For example, if the calibration object 53 is substantially planar, the 2D view may be suitable for guiding the user while having reduced processing requirements compared to the 3D view, while the 3D view may be advantageous for more complicated shaped calibration objects 53 or when using an AR or VR device. The third user interface screen 83 may further include an indication of a total number of calibration features and optionally may further include a key or legend indicating how the known, identified and unidentified calibration features may be distinguished.

The fourth user interface screen 84 may be an instruction interface. The instruction interface may comprise instructions for the user to perform the calibration process. By including the instruction interface, the user is assisted in performing the calibration process, as they are not required to remember all steps of the process. Further, the instruction interface may be updated to mark actions as complete or outstanding to further assist the user.

FIG. 9 is a flow chart illustrating a method 90 for performing an automated equipment calibration process. The automated equipment calibration process 90 is similar to the process described in FIG. 6 but involves receiving a scan of the calibration object 53 from a scanning device 55. The method 90 of FIG. 9 may be performed by the apparatus 40 of FIG. 4 or the system 50 of FIG. 5.

The method 90 comprises receiving 91 an image 71 of a calibration object 53 from a scanning device 55. As previously discussed, the image 71 may be a scan image, and may be obtained from a scanning device 55 such as a non-destructive testing apparatus.

The method 90 further comprises obtaining 92 a reference image 72 of the calibration object 53. The reference image 72 may be a master scan image and may be formatted similarly to the received image 71. The reference image 72 may include information associated with one or more known calibration features 74 (such as artificial defects) of the calibration object 53. The reference image may be obtained in various ways, as previously discussed in respect of FIGS. 4 to 6.

The method 90 further comprises outputting 93 the received image 71 and the reference image 72. For example, the received image 71 and the reference image 72 may be output simultaneously (e.g., overlaid) as shown in FIGS. 7 and 8.

The method 90 further comprises identifying 94 one or more calibration features 73 based on an input signal received from the scanning device 55. The calibration features 73 may be based on comparing the input signal to data values included in the reference image 72. For example, for each known calibration feature 74 of the reference image 72, there may be an associated value for a measurement such as a signal amplitude or gain value (as discussed in respect of FIG. 3). The method 90 may comprise comparing the values associated with locations in the received image 71 with the known values associated with known calibration features 74 in order to identify the calibration features 73 in the received image 71. For example, calibration features 73 may be identified if a measurement associated with a location of a potential calibration feature 73 is within a predetermined range of a measurement associated with a known calibration feature 74 within a predetermined distance of the potential calibration feature 73. Alternatively, the input signal may include information identifying potential calibration features 73 determined by the sensing device 55.

The method 90 may further comprise comparing 95 the received image 71 and the reference image 72. For example, as previously discussed, image processing techniques may be used to determine whether a calibration feature 73 has been identified in the received image 71 corresponding to one or more of the known calibration features 74 of the reference image 72. For example, the method 90 may comprise comparing a location of identified calibration features 73 with known calibration features 74 and determining that a known calibration feature 74 has been successfully identified when an identified calibration feature 73 is within a predetermined distance of the known calibration feature 74 and/or when associated measurement values of the identified calibration feature 73 are within a predetermined range of measurement values associated with the known calibration feature 74. The method 90 may optionally comprise a step of aligning the received image 71 and the reference image 72 on the display unit before performing the comparison.

The method 90 may further comprise outputting 96 an indication of whether calibration features 73 of the calibration object 53 have been identified. For example, as illustrated in FIGS. 7 and 8, the method 90 may include displaying a user interface element indicating the identified calibration features 73, the known calibration features 74, and/or other user interface elements including information relating to a total number of calibration features, a number of identified calibration features, and/or a number of unidentified calibration features. For example, known calibration features 74 which are not associated with an identified calibration feature 73 may be highlighted in a particular color different to a color of known calibration features 74 which are associated with identified calibration features 73.

The method 90 may further comprise additional steps, for example based on the functions of the apparatus 40 described above in respect of FIGS. 4 and 6.

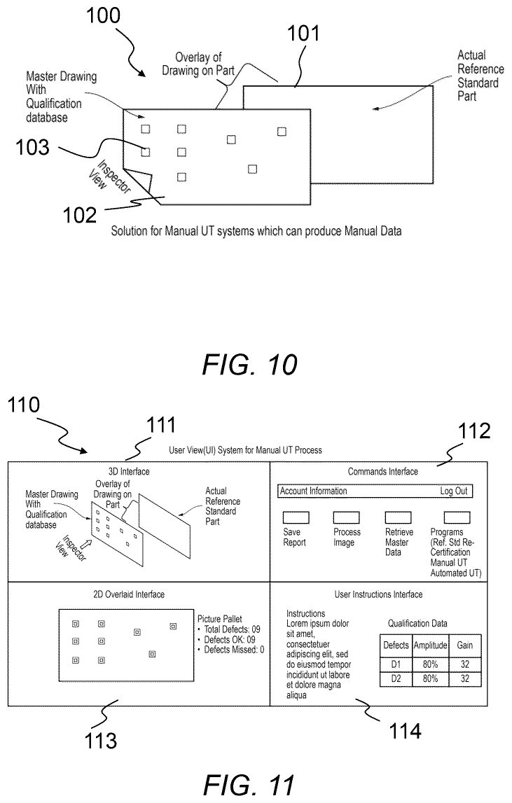

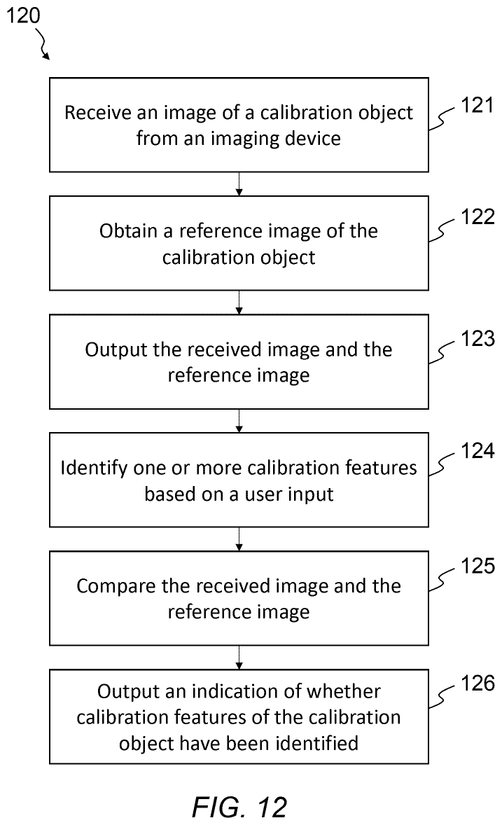

FIGS. 10 and 11 illustrate example user interface elements which may be output during a manual calibration process. The manual calibration process is described in respect of FIG. 12 and may be understood as a calibration process such as that described in respect of FIG. 6, where the method does not involve receiving a scan of the calibration object 53 from a scanning device 55. The manual calibration process may instead involve receiving an image of the calibration object 53 from an imaging device 54 such as a camera.

FIGS. 10 and 11 illustrate example user interfaces which are similar to those of FIGS. 7 and 8. Description of common elements will be omitted for brevity. For example, the user interfaces of FIGS. 10 and 11 include both 2D and 3D overlay interfaces, a command interface, and an instruction interface.

FIG. 10 illustrates an overlay interface 100 showing a reference image 102 including known calibration features 103 overlaid on an image 101 of the reference object 53. In this example, the image 101 of the reference object 53 may be captured by an imaging device, such as a camera. Thus, there may be no calibration features initially shown in the captured image 101.

The user interfaces 110 of FIG. 11 include a first user interface 111 showing a 3D overlay interface, a second user interface 112 showing a command interface, a third user interface 113 showing a 2D overlay interface, and a fourth user interface 114 showing an instruction interface. It should be understood that the user interfaces 110 may take different forms or may omit interfaces shown in FIG. 11 or include additional user interface screens.

The user interfaces 110 of FIG. 11 are similar to those of FIG. 8. However, as shown in FIG. 11, when an image 101 captured by an imaging device 54 is used instead of a scan image captured by a scanning device 55, the user interface 110 may in some examples include additional guiding information to assist the user. For example, as shown in FIG. 11, the instruction interface 114 may include information relating to an amplitude and/or gain associated with one or more of the known calibration features 103. Thus, the user may separately operate a sensing device or testing apparatus to identify the calibration features 103 with reference to the associated measurements or values. As discussed in respect of FIGS. 7 to 9, the user interface may update one or both of the received image 101 or the reference image 102 to indicate calibration features 103 which have been identified, or which have not been identified.

FIG. 12 is a flow chart illustrating a method 120 for performing a manual equipment calibration process. The manual equipment calibration process 120 is similar to the process described in FIG. 6 but involves receiving a captured image of the calibration object 53 from an imaging device 54. The method 120 of FIG. 12 may be performed by the apparatus 40 of FIG. 4 or the system 50 of FIG. 5.

Steps 121 to 123 of the method 120 of FIG. 12 are similar to steps 91 to 93 of the method 90 of FIG. 9 and steps 61 to 63 of FIG. 6, and description of these steps will therefore be brief to avoid repetition. The method 120 includes receiving 121 an image of a calibration object 53 from an imaging device 54. The method 120 includes obtaining 122 a reference image of the calibration object 53. The reference image may be obtained in the same ways as previously described. The method 120 comprises outputting 123 the received image 101 and the reference image 102. The received image 101 and the reference image 102 may be overlaid as shown in FIGS. 10 and 11.

The method 120 may further comprise identifying 124 one or more calibration features based on a user input. For example, the user may make an input to confirm that one or more of the known calibration features 103 shown in the reference image 102 have been identified (for example using a separate scanning 55 or testing apparatus). The user may optionally enter measurement values (e.g., a signal amplitude or gain value) associated with a calibration feature.

The method 120 may further comprise comparing 125 the received image 101 and the reference image 102. The comparison may include the use of image processing techniques as previously described to determine which of the known calibration features 103 of the reference image 102 have been identified. It should be understood that this step is optional.

The method 120 may further comprising outputting 126 an indication of whether the known calibration features 103 of the calibration object 53 have been identified. As previously discussed, the user interface may be updated to indicate the identification of calibration features 103. For example, an indication may be displayed on the received image 101 of an identified calibration feature, or an indication may be displayed on the reference image 102 indicating that a known calibration feature 103 has been identified. The indication may take a text form (e.g., a GUI may be displayed confirming that a particular calibration feature 103 has been identified), or the existing GUI indicating the known calibration feature 103 may be updated to indicate that it has been successfully identified, for example by changing color. Alternatively, or in addition, the user interface may display information relating to a total number of calibration features of the calibration object; a number of identified calibration features; a number of unidentified calibration features; or instructions to scan the calibration object at an area associated with an unidentified calibration feature.

It should be understood that the method 120 may further comprise additional steps, for example based on the functions of the apparatus 40 described above in respect of FIGS. 4 and 6. Further, the method 120 may omit several of the steps shown in FIG. 12. For example, the method 120 may omit the identification of calibration features 103 and/or the comparison of the received image 101 and the reference image 102.

As described above with reference to the Figures, the present disclosure provides an apparatus and methods for assisting a user during an equipment calibration process. The apparatus and methods output information which guide the user to interact with testing or sensing equipment and calibration objects to ensure that the testing equipment is properly calibrated. As has been described, in some examples the apparatus 40 is an AR or VR wearable device and presents a reference image of the calibration object overlaid on an image of the calibration object received from an imaging device or a scanning device. Thus, the user is continuously guided during their interaction with the apparatus and/or the scanning device.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Where the word ‘or’ appears, this is to be construed to mean ‘and/or’ such that items referred to are not necessarily mutually exclusive and may be used in any appropriate combination.

Although the invention has been described above with reference to one or more preferred embodiments, it will be appreciated that various changes or modifications may be made without departing from the scope of the invention as defined in the appended claims.

Claimed is:

1. An apparatus for guiding an equipment calibration process, the apparatus comprising:
one or more processors configured to:
receive an image of a calibration object;
obtain a reference image of the calibration object, the reference image comprising a representation of the calibration object and a graphical element indicative of one or more calibration features of the calibration object;
simultaneously output the image and the reference image on a display unit; and
output, on the display unit, an indication of whether one or more of the one or more calibration features of the calibration object have been identified in the image.

2. The apparatus according to claim 1, wherein the one or more processors are further configured to identify one or more of the one or more calibration features in the image.

3. The apparatus according to claim 2, wherein the one or more processors are further configured to receive a measurement associated with an identified calibration feature, or
wherein the one or more processors are further configured to receive a user input identifying a calibration feature in the image,
or both.

4. The apparatus according to claim 2, wherein the apparatus is communicatively coupled to a scanning apparatus, and
wherein the one or more processors are further configured to identify the one or more calibration features based on an input signal received from the scanning apparatus.

5. The apparatus according to claim 2, wherein the one or more processors are further configured to compare, using image processing techniques, the image to the reference image to determine whether the one or more calibration features of the calibration object indicated in the reference image have been identified in the image.

6. The apparatus according to claim 5, wherein the one or more processors are further configured to visually highlight at least one of the one or more calibration features of the reference image which are not identified in the image.

7. The apparatus according to claim 2, wherein the one or more processors are further configured to receive a user input indicative of an identified calibration feature in the image corresponding to a calibration feature of the reference image.

8. The apparatus according to claim 1, wherein the one or more processors are further configured to overlay the reference image over the image.

9. The apparatus according to claim 8, wherein the one or more processors are further configured to align the reference image over the image using image processing.

10. The apparatus according to claim 1, wherein the one or more processors are further configured to output a user interface element indicating one or more of: a total number of calibration features of the calibration object; a number of identified calibration features; a number of unidentified calibration features; or instructions to scan the calibration object at an area associated with an unidentified calibration feature.

11. The apparatus according to claim 1, further comprising:
a virtual reality, VR, or augmented reality, AR, wearable device.

12. The apparatus according to claim 1, wherein the one or more processors are further configured to obtain the reference image from a memory of the apparatus or an external server storing a plurality of reference images associated with a respective plurality of calibration objects, or
wherein the one or more processors are further configured to obtain the reference image based on one or more of: a user input selecting the reference image from the plurality of stored reference images; an identifier of the calibration object detected in the received image; or performing object recognition on the image and identifying a type of the object in the image, or
both.

13. The apparatus according to claim 1, wherein the reference image comprises one or more 2D images of the calibration object or a 3D image of the calibration object.

14. The apparatus according to claim 1, wherein the apparatus is communicatively coupled to an imaging device configured to capture the image of the calibration object, or the apparatus is communicatively coupled to a scanning device configured to perform non-destructive testing on the object; and
wherein the image of the calibration object is received from the imaging device or the scanning device.

15. The apparatus according to claim 1, wherein the apparatus is communicatively coupled to a scanning apparatus and the scanning apparatus is an ultrasound or x-ray scanning device, or
wherein the one or more calibration features comprises an artificial defect, or both.

16. The apparatus according to claim 1, wherein the one or more processors are further configured to generate a report to certify that all of the one or more calibration features of the reference image have been identified in the image, and that the equipment calibration process has been completed.

17. The apparatus according to claim 1, wherein the reference image further comprises calibration feature data associated with the one or more calibration features,
wherein said calibration feature data comprises a signal amplitude of an artificial defect, or a gain value of the artificial defect, or both, and
wherein the one or more processors are further configured to display the calibration feature data on the display unit.

18. A method for guiding an equipment calibration process, the method comprising:
receiving an image of a calibration object;
obtaining a reference image of the calibration object, the reference image comprising a representation of the calibration object and a graphical element indicative of one or more calibration features of the calibration object;
simultaneously outputting the image and the reference image on a display unit; and
outputting, on the display unit, an indication of whether one or more of the one or more calibration features of the calibration object have been identified in the image.

19. The method according to claim 18, wherein the calibration object is an aircraft component, or
wherein the one or more calibration features comprises an artificial defect, or both.

20. A method for calibrating a non-destructive testing apparatus, the method comprising the steps of:
selecting a control sample corresponding to a component to be inspected, and retrieving a reference standard corresponding to the control sample among a plurality of reference standards in a computer-readable storage medium, wherein each reference standard is associated with a respective one of a plurality of control samples, wherein each control sample features an artificial defect, wherein the reference standard comprises a master image of the control sample indicating the location of the artificial defect;
capturing an image of the control sample using a non-destructive testing apparatus;
displaying the image of the control sample on a display unit, wherein the master image is overlaid onto the image; and
determining, based on the image and the master image, whether or not the artificial defect has been detected by the non-destructive testing apparatus.
